(19) United States
(12) Patent Application Publication
(10) Pub. No.: US 2007/0198562 A1
(43) Pub. Date: Aug. 23, 2007

(54) Method and Apparatus for Ensuring Business Process Integration Capability for one or more Distributed Component Systems in Communication with one or more Legacy Systems

(75) Inventors: Vinay Vasant Kulkarni, Pune (IN); Sreedhar Sannareddy Reddy, Pune (IN); Souvik Barat, Pune (IN)

Correspondence Address: CENTRAL COAST PATENT AGENCY, INC, 3 HANGAR WAY SUITE D, WATSONVILLE, CA, 95076, US

(73) Assignee: TATA CONSULTANCY SERVICES LIMITED, Mumbai (IN)

(21) Appl. No.: 11/695,875

(22) Filed: Apr. 3, 2007

Related U.S. Application Data
(63) Continuation-in-part of application No. 10/038,012, filed on Jan. 2, 2002, now abandoned.

(30) Foreign Application Priority Data
Aug. 14, 2001 (IN) 796/MUM/2001

(51) Int. Cl. G06F 17/30

(52) U.S. Cl. 707/101; 707/10

(57) ABSTRACT

In a system for bridging one or more legacy systems with one or more component systems for data communication, a method for integrating application processes with one another includes steps for (a) expressing all application behavior using a modeling language; (b) transforming those expressions into process automata; (c) organizing composition settings comprising the process automata; and (d) analyzing process automata for integration safety and for integration completeness properties of the process automata using a deterministic finite automata library and leveraging its base functions.

### CROSS-REFERENCE TO RELATED DOCUMENTS

The present patent application claims priority to a U.S. patent application Ser. No. 10/038,012, filed on Jan. 2, 2002, which claims priority to a foreign provisional patent application serial number 796/MUM/2001 filed in India on Aug. 14, 2001. The prior applications contain disclosure, which is incorporated herein in its entirety by reference.

### FIELD OF THE INVENTION

The present invention is in the field of computerized information systems and pertains in particular to a system for ensuring business process integration capability for one or more distributed component systems with one or more legacy systems.

### BACKGROUND OF THE INVENTION

Large businesses and organizations typically consolidate all of their important data using computerized information systems. A legacy system is loosely defined as any information system that, by nature of its architecture and software structure, significantly resists system evolution or change.

Legacy systems typically form the main portion of information flow for an organization, and usually are the main vehicles for information consolidation for the host business or organization. Loosely defined attributes of a legacy system include being hosted on old or even obsolete hardware that is computationally slow and prone to expensive maintenance. Likewise, the software of a legacy system is generally not well understood and is often poorly documented. Therefore integration of legacy systems to newer software/hardware information systems or peripheral systems is burdensome, due to lack of clean interfaces. Adapting a legacy system to provide state-of-art function according to today's computational standards is extremely risky and burdensome using prior art techniques. Many prior art techniques are not proven and are still, at the time of this writing, a subject of considerable ongoing research.

As companies mature and evolve, it becomes important to be able to adapt their computing and information processing capabilities to a more competitive, technologically advanced, and fast-paced environment. But because their legacy systems are critical components to their continued success, much effort and expense must be undertaken in attempting to either completely rewrite the legacy systems or to attempt to move or migrate the system data and function into a more efficient, functional and cost-effective computer environment.

Rewriting a legacy system from scratch is usually not a viable option, because of the inherent liabilities of the system, the risk of failures, data loss, and poor understanding of how the system actually performs internally. Legacy systems are by design closed architectures and are not readily compatible with today's software and hardware architectures. Most organizations prefer to migrate their legacy systems to more efficient and easily maintainable target environments. This is called system migration in the art. System migration is an attempt to salvage the functionality of and data integrity within a legacy system as well as to enable added functionality to the system without having to redevelop the entire system.

The most common state-of-art technique for legacy system migration is the use of a connectivity or middleware software such as the well-known CORBA (Common Object Request Broker Architecture). CORBA is just one of several major distributed object-oriented infrastructures.

The design of CORBA is based on the OMG Object Model. The OMG Object Model defines common object semantics for specifying externally visible characteristics of objects in a standard and implementation-independent way. In this model clients request services from objects, also sometimes called servers, through a well-defined and clean interface. A client accesses an object (server) by issuing a request to the object. The request is an event, and it carries information including an operation, the object reference of the service provider, and any actual parameters. The object reference equates to an object name that defines an object reliably. Another common framework used as middleware in legacy system migration is the well-known object linking and embedding/common object modeling (OLE/COM).

Conventions such as CORBA and other component-based frameworks can be effective in allowing component objects to discover each other and interoperate across networks. Generally speaking however, direct usage of any of these middleware softwares in system migration is quite expensive, and as an art in itself is fraught with ad hoc procedures and high component failure possibilities. Few migration frameworks can claim even limited success.

The inventor is aware of a system for adapting at least one legacy system for functional interface with at least one component system. The system architecture includes a data reconciliation bus for enabling reconciliation of redundant data between legacy systems, at least one component wrapper within the architecture for describing a legacy system, at least one component object within the architecture for describing a component system, and a connectivity bus within the architecture between at least one component object and at least one component wrapper, the bus for extending legacy function to the at least one component system. In a preferred embodiment, a user operating a GUI has access to legacy services in an automated client/server exchange wherein heterogeneous data formats and platform differences of the separate systems are resolved in an object-oriented way that is transparent to the user.

It has occurred to the inventor that, in general, enterprise applications are designed to operate in a specific context. The content-specific assumptions are encoded into the implementations of these applications. These assumptions may lead to conflicts when integrating one application with other enterprise applications. To have safe integration, such content specific conflicts must be identified and mitigated.

To further exemplify, consider that an enterprise application A0 is a target application that needs to be realized through maximum reuse of existing applications A1, A2, through . . . An. For safe integration, it needs to be established whether an existing process view of A1 fits into the context of the desired process view of A0 or not and so on for each existing application that will be process integrated. In case of a mismatch, one would like to know if the existing process view could be made to fit with some adaptation.

What is clearly needed in the art is a set of tools and a framework for ensuring that multiple applications in communication with legacy systems are fully and safely integrated according to context specific behaviors and process views.

### SUMMARY OF THE INVENTION

In a system for bridging one or more legacy systems with one or more component systems for data communication, a method is provided for integrating application processes with one another. The method includes steps for (a) expressing all application behavior using a modeling language; (b) transforming those expressions into process automata; (c) organizing composition settings comprising the process automata; and (d) analyzing process automata for integration safety and for integration completeness properties of the process automata using a deterministic finite automata library and leveraging its base functions.

In one aspect, in step (a), the modeling language used is business process execution language based. In one aspect, in step (a), the applications include both internal and external applications with respect to the enterprise. In a preferred aspect, in step (b), the expressions represent process views of the applications.

In one aspect of the method in step (b), the process automata are expressed in Esterel programming language. In a preferred aspect, in step (b), an integration safety property and an integration completeness property are introduced and specified for each process automation as part of the transformation.

In all aspects, in step (c), the composition setting comprises the process automata of the application desired to be integrated and process automata of participating applications. In one aspect, the integration safety property has the sub-attributes of compatibility and conformance.

In one aspect of the method, there is a further step (e) for providing feedback to a system operator of any conflict to safe or complete business process integration found in step (d).

According to another aspect of the invention, a process integration framework is provided for enabling business process integration for multiple enterprise applications. The framework includes a model transformation module, a language compiler, and an analyzer module having access to a code library. The framework enables a desired application process automation to be analyzed for integration safety and integration completeness in the context of other participating application process automata.

In one embodiment, the framework is integrated with a system for bridging one or more legacy systems for communication with one or more new component systems. In one embodiment, the framework is installed on a single machine connected to a network. In another embodiment, the framework is installed over two or more machines connected to a network.

In one embodiment, the model transformation module converts BPEL4WS to Esterel and the language compiler is an Esterel compiler. In one embodiment, the code library is a deterministic finite automata library hi this embodiment, the analyzer leverages the base functions of the library to analyze the process automata. In a preferred embodiment, the safety and completeness properties are specified using operators and relations. In this embodiment, the operators and relations include a restriction operator, a compliment operator, an event inclusion relation, a simulation relation, a partial simulation relation, and a collective simulation relation.

### BRIEF DESCRIPTION OF THE DRAWING FIGURES

FIG. 1 is a block diagram illustrating an architectural overview of an object-oriented system enabling coexistence between legacy systems and state-of-art components according to an embodiment of the present invention.

FIG. 2 is a block diagram illustrating the components and attributes of an object façade for wrapping a legacy system according to an embodiment of the present invention.

FIG. 3 is a block diagram illustrating components and attributes of a data reconciliation bus according to an embodiment of the present invention.

FIG. 4 is a block diagram illustrating tool support for system automation according to an embodiment of the present invention.

FIG. 5 is a process flow chart illustrating process steps for wrapping a legacy system as an object façade.

FIG. 6 is a block diagram illustrating a legacy migration system architecture integrated with a framework supporting process integration according to an embodiment of the present invention.

FIG. 7 is a block diagram illustrating some basic components of process integration framework of FIG. 6.

FIG. 8 is a process flow diagram illustrating steps for integrating business processes and for validating the safety and completeness of the integration process according to an embodiment of the present invention.

### DESCRIPTION OF THE PREFERRED EMBODIMENTS

A goal of the present invention is to provide a comprehensive approach for integrating legacy systems to distributed component systems as opposed to complete system rewrites or migrations. The solution provided by the inventor addresses three main problem areas preventing prior-art integration of legacy systems with new components. The first of these problem areas is that there is currently no known middleware-independent (open) framework for interfacing legacy systems with new components. Secondly, there is no known technique for integrating a legacy system or systems within component development frameworks. Finally, there is no practical method of data reconciliation across multiple disconnected legacy systems.

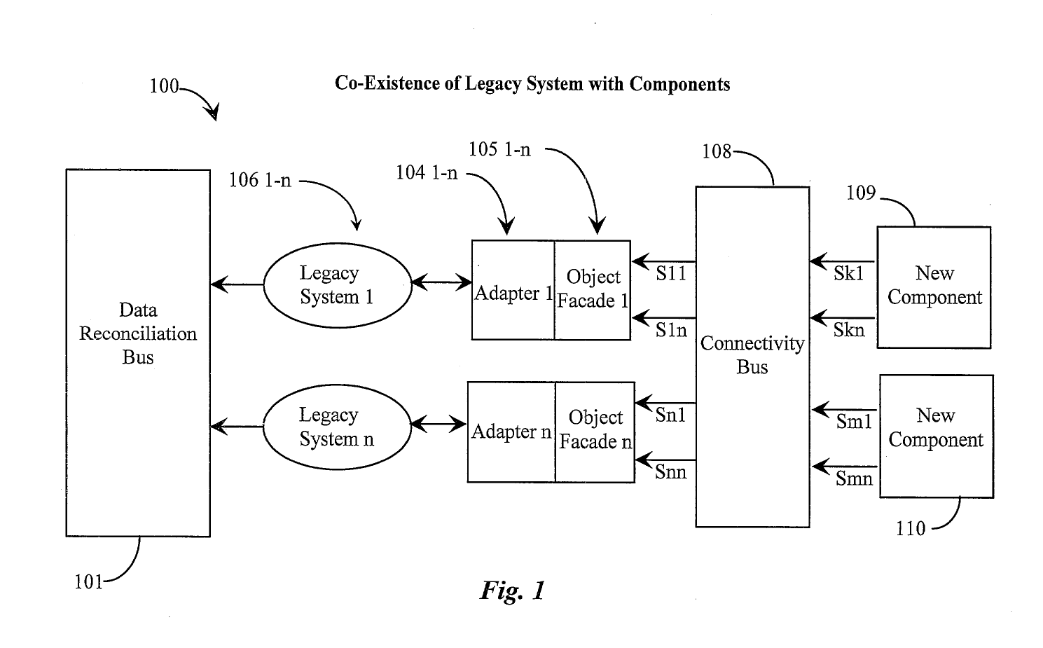

A goal of the present invention is to provide an integration solution enabling continued use and enhancement of enterprise legacy systems, the solution comprising primarily of an open, distributed, and platform-agnostic component architecture (see FIG. 1) enabling the co-existence of existing legacy systems with component-oriented distributed systems. A solution includes a novel technique for wrapping a legacy system as a component object and a technique for optimizing existing function of a legacy system and minimizing disuse or component obfuscation of the legacy system. Still other mission-critical improvements include provision of a generic connectivity bus and a novel data reconciliation bus for addressing redundancy issues between multiple legacy systems as well as tools automating the system integration process.

FIG. 1 is a block diagram illustrating an architectural overview of an object-oriented system 100 enabling coexistence between existing legacy systems and state-of-art components according to an embodiment of the present invention. System 100 is provided as an object-oriented architecture and adapted, in this case, to facilitate functional integration of multiple legacy systems illustrated herein as legacy systems 106 1-n with multiple, distributed components illustrated herein as components 109 and 110.

System 100 incorporates component wrappers for each legacy system 1-n illustrated herein as object facades 105 1-n. Object facades 105 1-n correspond to legacy systems 106 1-n. An object façade is a package that contains references to model elements. The main purpose or goal of an object facade is to represent a legacy system as an abstract object model that provides a defined plurality of services expected of the system from an external environment. A single legacy service can be defined as an n-tuple consisting of a name, at least one input parameter, and at least one output parameter. It is assumed in this example that legacy systems being reengineered utilize RDBMSs.

In this example of multiple legacy systems, a transaction boundary may be assumed to extend across multiple legacy systems 106 1-n. Therefore, RDBMSs inherent to those legacy systems must be XA compliant. XA is one of several available standards known in the art for facilitating distributed transaction management between a transaction manager and a resource manager.

Each object facade 105 1-n in this example has integrated therewith an adapter illustrated in this embodiment as adapters 104 1-n (one per instance). An adapter is responsible for handling data transformation from the closed (private) environment of an associated legacy system to an open (public) environment of object-oriented architecture 100. That is to say that closed language format inherent to the legacy systems is converted to an open non-proprietary format for output distribution to new components 109 and 110 and the open format of those systems is converted by the adapter into the closed legacy formats inherent to the legacy systems for input into those systems. It is noted herein that each adapter is unique to an associated legacy system because of disparate data formats common among disconnected systems.

A unique data-reconciliation bus structure 101 is provided in this embodiment as part of system 100 and is adapted to provide a solution to data redundancy across disconnected legacy systems 106 1-n. For example, if there are data entries in a table owned by legacy system 106 1, but not in the same table existing in but not owned by legacy system 106n, the redundant data has to be propagated to legacy system 106n. Likewise, data entries existing in a table owned by legacy system 106n, but not existing in the same table existing in but not owned by legacy system 106 1 have to be propagated to legacy system 106 1. Data reconciliation across multiple legacy systems 106 1-n can be preformed in a batch process. Data reconciliation across multiple legacy systems facilitates better consistency in modeling distinct legacy services.

A connectivity bus 108 is provided as part of system 100 and is adapted to transform object-oriented data in an open format into data formats usable by new components 109 and 110. Likewise, data input from new components 109 and 110 is transformed into object-oriented data in an open format definable at the middleware level of object facade.

Connectivity bus framework expressed in most basic form is represented in syntax as follows:

Class Connector
{
public:

| // API to invoke a service in synchronous manner | |
|---|---|
| virtual ErrorStatus callService ( Request *svcName )= 0; | |
| // API for obtaining input parameters of a service | |
| virtual ErrorStatus getParamsFromBuffer( DArray *in ); | |
| // API for returning from a service | |
| virtual ErrorStatus returnAcrossNetwork ( Response *svcName ); | |
| // API for obtaining return values of a service | |
| virtual ErrorStatus returnedFromService ( Darray *out ); | |
| // API to invoke a service in asynchronous manner | |
| virtual ErrorStatus callAService ( Request *svcName, Token | &token ); |
| // API to invoke a service in queued manner | |

virtual ErrorStatus callQService ( Request *svcName, Queue *inQ );
// API to poll a service invoked in asynchronous manner
virtual ErrorStatus checkReply ( Token *token );
// API to poll a queue
virtual ErrorStatus checkStatus ( Queue *inQ, Qstatus &qs );
};

Class Request
{
private:

| char *svcName; | |
|---|---|
| TxnInfo *tinfo; | // Transaction information |

| | |
|---|---|
| Darray *in; | // Darray of input parameters |

Public:

Char *getSvcName( );
Void setSvcName( char *name );
TxnInfo *getTxnInfo( );
Void setTxnInfo( TxnInfo *ti );
ErrorStatus AddParam( Object *p );
Int sizeof( );
Void serialise( char *buf );
Void unserialise( char*buf);

};
Class Response
{
private:

| char *svcName; | |
|---|---|
| ErrorStatus status; | // Status of invocation |
| Darray *out; | // Darray of return values (in/out + out) |
| Darray *errs; | // Darray of (application) error objects |

Public:

Char *getSvcName( );
Void setSvcName( char *name );
ErrorStatus *getStatus( );
Void setStatus( ErrorStatus st );
ErrorStatus AddParam( Object *p );
ErrorStatus AddError( Object *e );
Int sizeof( );
Void serialise( char *buf );
Void unserialise( char *buf );

};

Connectivity bus 108 can be any standard middleware. In this example, new component 109 accesses services modeled in façade 105 1. Any of Sk1-Skn may invoke any of legacy services 1-n. Connectivity bus 108 resolves the requests to S11 through S1n as represented in the component wrapper (façade 105 1). Adapter 104 1 provides the defined set of legacy services in the form of modeled services S11-S1n. In this way, new components have integrated access to legacy data through an open (public) architecture.

A key process identified and facilitated by system 100 is the ability to define a legacy system, rather, all of the services to be invoked from external world, as an object model. First, by modeling individual legacy services and then by modeling a defined reference set of those service objects into an object that completely describes an entire legacy system accomplishes this goal. More detail about modeling legacy system services is provided below.

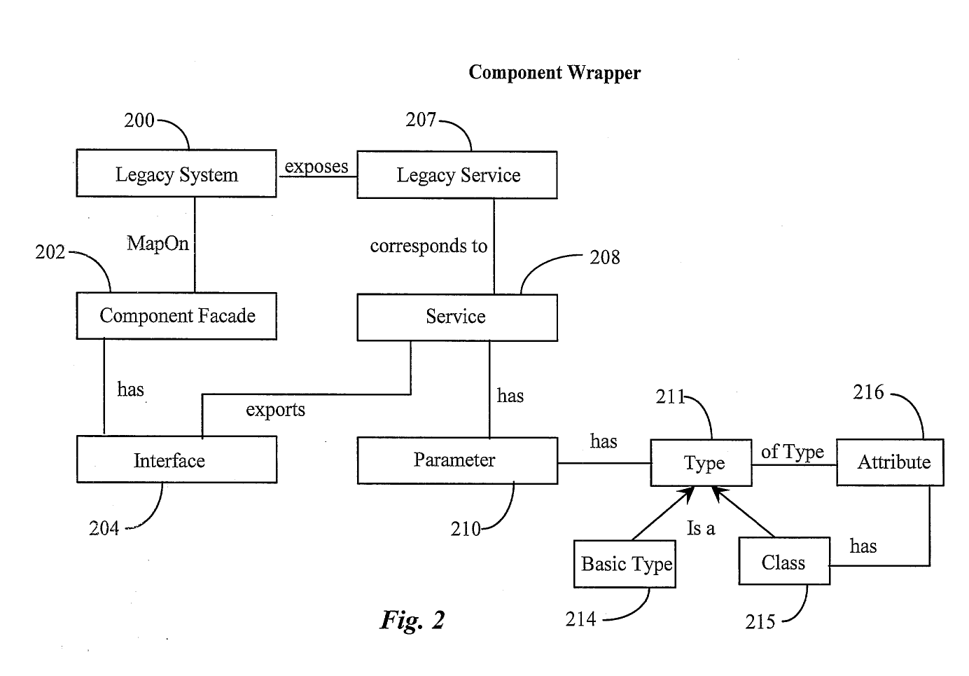

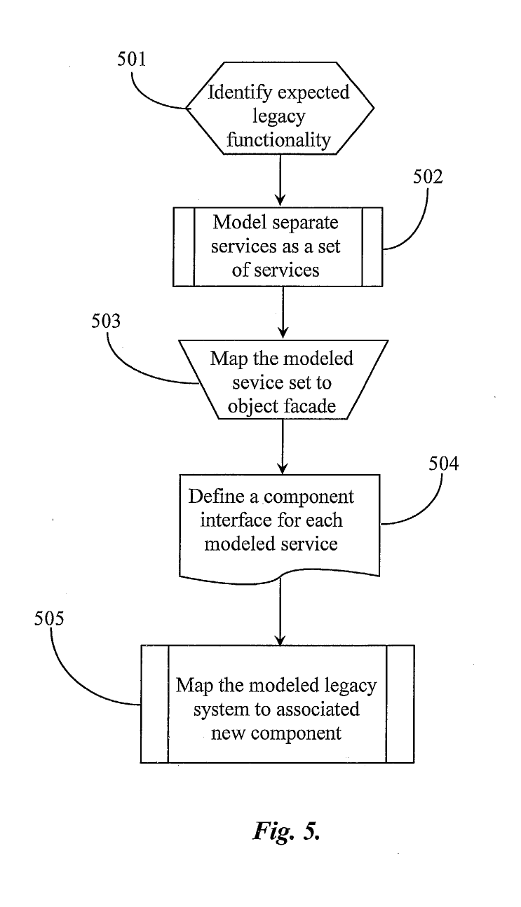

FIG. 2 is a block diagram illustrating the object model of an object facade 105 1-n for wrapping a legacy system to enable interaction with new components according to an embodiment of the present invention. Wrapping a legacy system as an object involves basic steps, which are, in a preferred embodiment, performed in a stated order as described with reference to FIG. 5.

Referring now to FIG. 5, at step 501, functionality of a particular legacy system is identified in terms of expectations of the system from an external environment. At step 502, individual services of the legacy system are identified, aggregated and then specified as a set of services in the type system of the particular legacy system. These services are listed as n-tuples representing individual services having a service name, its input parameters and its output parameters. In this regard, a set of services must have clearly defined input and output parameters. Object modeling is utilized to create a service model of a legacy system. At step 503, a modeled service-set (Object model) representing a legacy system is used to generate a component facade having interface operations, which are specific to the individual services defined in step 502. The component façade (object façade) contains references to all service objects.

For each service identified in step 502 an interface operation is defined in the type system of the open component architecture as an n-tuple. An n-tuple has a method name, a set of input parameters, and a set of output parameters as described briefly above. At this stage a functioning object model (object facade) representing a legacy system is completely defined. The interface of the object facade provides access to the legacy system from an external component-oriented environment.

At step 505, the modeled legacy system is mapped from the legacy type system to a type system (object) of component architecture provided or developed to interact with the system. Such a map enables transformation of object functionality from the open façade (legacy) to an object representing the new component architecture. It is noted that the new component may contain additional objects that extend the functionality of the modeled legacy system services and/or objects that provide entirely new functions.

Component objects are developed to correspond to specific legacy object facades and one component may interact with more than one legacy system. Using this basic technique, legacy systems are reengineered into pure server-side components that are devoid of a graphical user interface (GUI). The server-side components are not available for GUI until they are brought into the open architecture where there are well-defined and distinct layers of presentation and business functionality. A driver component as known in the art is provided and adapted to define a control flow over the services and a business realization view in terms of the services wherein the view is a GUI for the reengineered legacy system.

Referring now back to FIG. 2, a legacy system for re-engineering is represented by a block 200 labeled Legacy System. A legacy system exposes at least one legacy service represented herein by a block 207, labeled Legacy service, that can be expressed as an n-tuple. Legacy service 207 corresponds to a modeled service or service object 208. Legacy system 200 is mapped as a set of services onto component façade 202. Component façade 202 has an interface 204, which contains all of the interface operations corresponding to all of the individual legacy services. Interface 204 exports service object 208 upon request, object 208 representing legacy service 207.

Service object 208 has at least one parameter 210, which has a system type represented herein as a block labeled Type and given the element number 211. Type 211 is a Basic Type illustrated herein as a block labeled Basic Type and given the element number 214, or a Class Type illustrated herein as a block labeled Class and given the element number 215. Type 211 is of Type expressed herein as an attribute represented by a block 216 labeled Attribute. Class type 215 has defined attribute 216. A component wrapper as illustrated in this example exactly references a modeled legacy system with respect to all of its capabilities expressed as n-tuples. Object modeling is, in a preferred embodiment, used to model services and generate the object façade from raw legacy services (n tuples).

The component wrapper (object façade) is of the same object Type and object Class as a corresponding new component system (object) as far as the open middleware framework is concerned. Connectivity bus 108 described with reference to FIG. 1 enables transformation of the common object parameters to data formats actually used by the new component system and platform. It is important to note herein that a new component system may be developed as part of the process for extending existing legacy function and/or for providing entirely new functionality. The end result is a legacy system access capability that is user-friendly in terms of input, access and return. Moreover, the transformation of heterogeneous data across the network (from server to client and from client to server) is completely transparent to the user. A user does not have to code for data transformations.

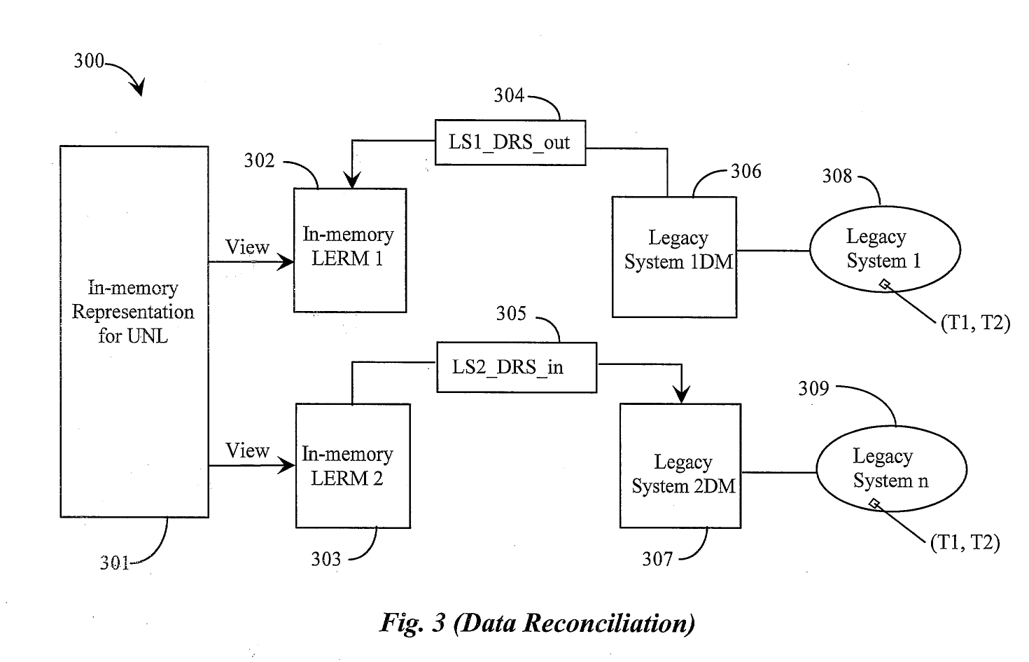

FIG. 3 is a block diagram illustrating logical components and attributes of a novel data-reconciliation bus according to an embodiment of the present invention. The common model for legacy systems and new components interacting with them is represented in memory as a unified and normalized layer (UNL). UNL is a complete data model of the reengineered application including the set of modeled legacy systems as well as the set of modeled new components. Therefore, the UNL data model is devoid of any data redundancies.

Updates to data owned by one legacy system need to be propagated to other legacy systems where the updated data needs to be replicated. Likewise, changes to data not owned by a legacy system need to be propagated to the system from any legacy system owning the data.

A memory block 301 is provided and represents the UNL, which represents the functional part of data bus schema 300. A single data model of a particular legacy system is expressed as an ER model. A legacy ER model is defined as a view over UNL.

In this example, a legacy system 1 (308) and a legacy system 2 (309) have redundant tables T1 and T2 between them such that system 1 (308) owns T1 and system 2 (309) owns T2. Updates of interest to T1 in system 1 need to be propagated to T1 in system 2 and updates of interest to T2 in system 2 need to be propagated to T2 in system 1. A legacy system 1 data model (DM) 306 represents the entire data model for legacy system 1 (308). A Block given the element number 304 represents legacy system 1 (LS1) data reconciliation service (DRS) out. LS1_DRS_out (304) is a user-initiated event for propagating updates of interest to T1 in system 1 out to UNL. A block labeled LS2_DRS_in (305) is a user-initiated event for propagating the T1update from UNL into T1 in system 2. It is noted herein that output of block 304 is input to block 305. The redundancy reconciliation is facilitated by an in-memory ER model 1 (LERM 1) 302 and an in-memory LERM 2 (303). The direction of update is illustrated herein by directional arrows from the data model (LDM 1) to the ER model (LERM 1) representing LS1_DRS_out and from the ER model (LERM 2) to the data model (LDM 2) representing LS2_DRS_in. The direction of update for T2 (owned by system 2) would be in reverse order wherein block 305 would read LS2_DRS_out and block 304 would read LSI_DRS_in.

An in-memory view over UNL or LERM 2 (303) from UNL 301 is updated with the required data structures and data. LSR_DRS_in 305 contains the updated data objects from updated LERM 2. These objects are then propagated into LS2 DM 307 and are incorporated into Legacy system 2 (309) thereby completing a redundancy reconciliation operation between LS2 and LS1.

The process mentioned above provides a solution to any undesired data redundancy that may exist or occur in the RDBMSs of multiple disconnected legacy systems being modeled.

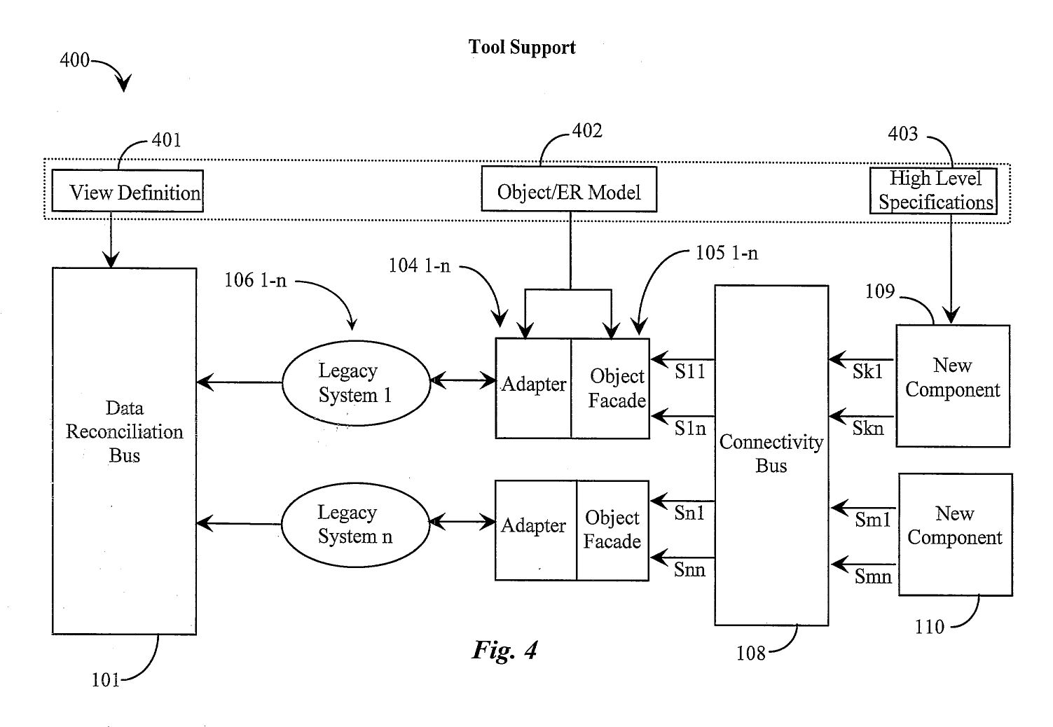

FIG. 4 is a block diagram illustrating tool support for system automation according to an embodiment of the present invention. The architecture of this example is much the same as the architecture described with reference to FIG. 1 above. Therefore, components illustrated in this example that are also present in the example of FIG. 1 retain their element numbers of FIG. 1 and shall not be re-introduced. Tool support for the reengineering system of the present invention includes an object-modeling tool (not shown) for defining object models of new components, services of legacy systems, and interface operations of component façades.

An ER modeling tool 402 is provided and adapted for defining ER models representing individual legacy systems. Object models along with versioning and configuration management parameters are stored in a robust, multi-user object repository (not shown). A high level programming language represented herein by a block labeled High Level Specifications and given the element number 403 is incorporated for specifying mediator functionality between new components and legacy facades. A mechanism is provided for modeling a GUI of a reengineered application and generating user friendly and open GUI.

A block labeled View Definition and given the element number 401 represents a mechanism to define an ER (object) model as a view over UNL and a view over another ER (object) model. In this example object facades and new component object models are completely generated from ER models. Tool support for developing new components that will work with existing legacy systems is available with the inventor.

It will be apparent to one with skill in the art that the approach to reengineering legacy systems to be integrated with new components can be accomplished using the novel embodiments of the invention described herein without requiring closed middleware solutions.

Process Integration

According to one embodiment of the present invention, the inventor provides a method for ensuring safe and complete integration of processes and services across multiple applications and a supporting framework enabling automation of the process and feedback of any conflicts. The method and apparatus are explained in enabling detail below.

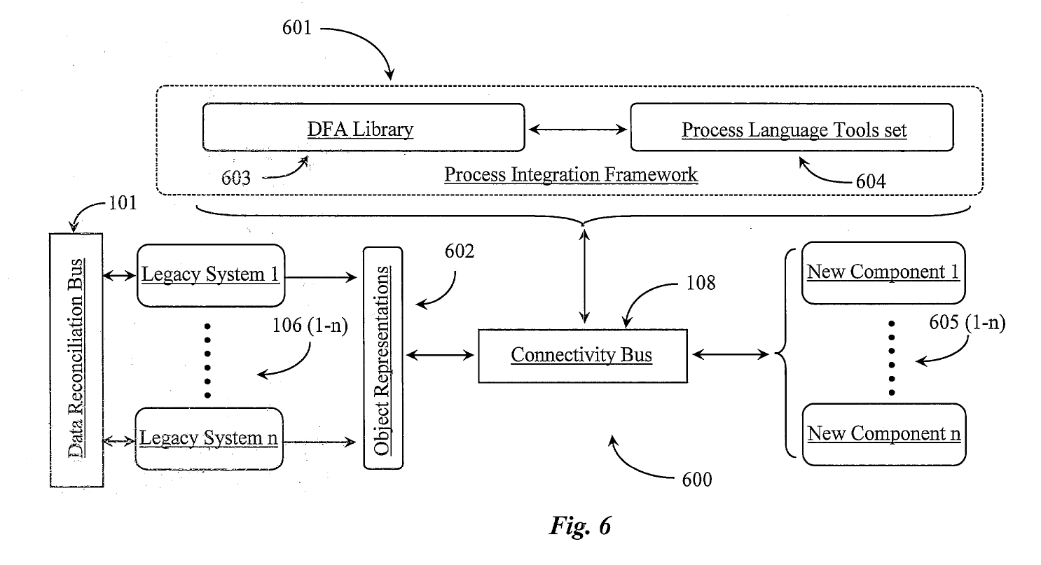

FIG. 6 is a block diagram illustrating a legacy migration system architecture 600 integrated with a framework 601 supporting process integration according to an embodiment of the present invention. Legacy migration system architecture 600 is analogous to architecture 100 described with reference to FIG. 1 of the co pending application. Many of the components of architecture 600 are in fact labeled with the same element numbers used in FIG. 1.

For purpose of discussion and review, system architecture 600 includes legacy systems 106 (1-n). Data reconciliation bus 101 takes care of redundancy issues between the legacy systems while in use.

Systems 106 (1-n) are connected to object representations 602 in this example. Object representations 602 describe in abstract the individual object facades 105 (1-n) and object adaptors 104 (1-n) illustrated in FIG. 1. Object representations 602 may therefore be assumed to collectively include all of the individual facades and adaptors for each connected legacy system. The object façade presents the legacy services to the outside world.

New component systems 605 (1-n) are analogous to component systems 109 and/or 110 illustrated in FIG. 1. New component systems 605 (1-n) are able to communicate with legacy systems 106 (1-n) through object representations 602 by means of connectivity bus structure 108.

A process integration framework 601 is provided according to an embodiment of the present invention and is illustrated in this example connected to system architecture 600 via connectivity bus structure 108. Process integration framework 601 includes among other components, at least one but possibly many process modeling language tool sets 604 used to define process views and for transforming them into more sophisticated or higher level languages to facilitate seamless integration. Process integration framework 601 includes among other components, a deterministic finite automata (DFA) library 603 for use in analyzing process automata and validating safe and complete integration properties.

Process integration framework 601 may be provided as a software/hardware solution such as on a powerful workstation. In one embodiment, process integration framework may be distributed over several connected or networked machines. It can be provided as an online solution or as an in-house solution without departing from the spirit and scope of the present invention. In a preferred embodiment, most of the processing is fully automated and mitigating possible conflicts or obstacles to complete process integration may be performed by a qualified knowledge worker or workers having access to a user interface (not illustrated) connected to the framework. In one embodiment where the enterprise uses applications that are external to the enterprise, the system enables process integration relevant to both enterprise internal and enterprise external applications.

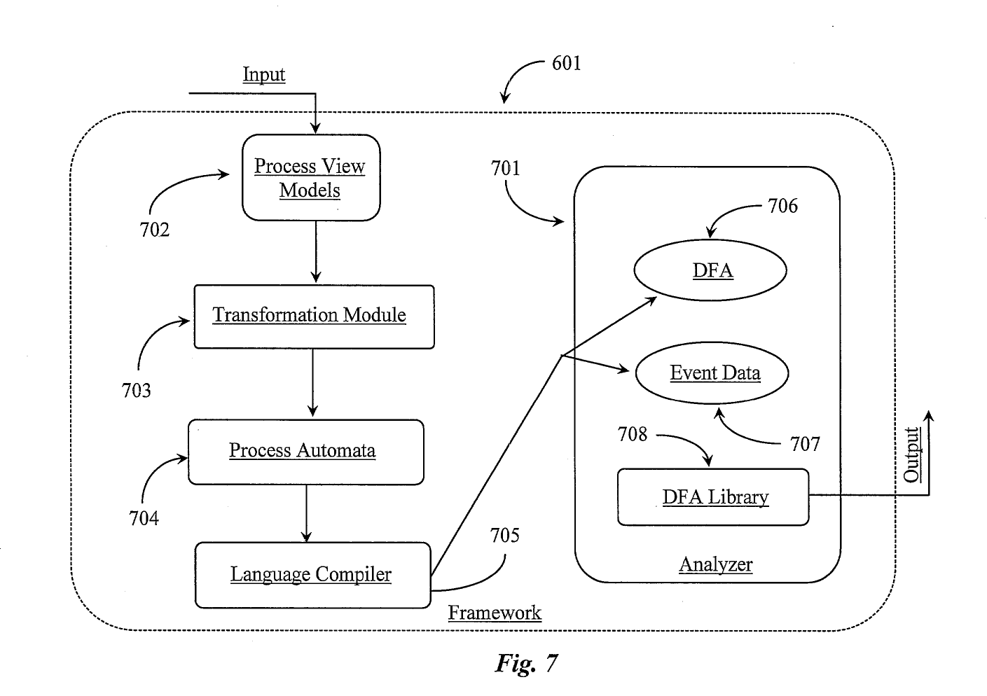

FIG. 7 is a block diagram illustrating some basic components of process integration framework 601 of FIG. 6. Framework 601 has at least one input port or queue for accepting process view models 702. Process view models 702 describe the behavior of one or more enterprise applications. In one embodiment process view models 702 are created using business process execution language (BPEL), which may also include an extension for capturing Web services. (BPEL4WS). The actual behavior represented is a control flow over a set or process activities. The process view model is a relative higher-level representation that may be transformed into a lower-level representation such as a finite state automaton (FSA). A FSA includes a finite number of states and transitions.

A finite state automon or, collectively, process automata is enhanced by specifying two observable properties. These are a safety property and a completeness property. The safety property defines a condition of whether a process view may fit into a desired process integration context without any type of conflict. If there is a conflict, it is preferable that that conflict may be reported as feedback and that the user then could mitigate that conflict. In one embodiment, such conflicts may be mitigated using mediation techniques.

The completeness property refers to a property of multiple process views grouped together as a composition setting. Generally these are a process view of a desired integrated application and several or more process views of other participating applications. Together these views comprise a composition setting that can be validated for the completeness property. The completeness property has to do with validating behavioral completeness of the composition setting by collectively analyzing each of the included process views for completeness with respect to the desired integrated process view.

A Transformation module 703, which in one embodiment may be template based, is used to transform a process view into a process automata 704. A language compiler is used to convert the model notation into yet higher-level notation for analysis against a deterministic finite automata. (DFA) library illustrated by a link 708. Link 708 provides access to a robust DFA library that is accessible to a DFA analyzer 701 provided as part of the process integration framework.

Process integration framework 601 has at least one output port or queue for providing feedback about process integration activities, including feedback that identifies conflicts and/or obstacles to complete and safe process integration according to accepted enterprise business process rules.

Compiler 705 may be an Esterel compiler in one embodiment, which may include a pre-compiler for sorting out event data. In a most simple embodiment, the process view 702 may be transformed into a process automon without a specific language evolution. In one embodiment, process integration framework 601 is implemented to perform the entire process of integration. In a variation of this embodiment, BPEL4WS is used to specify the initial business processes. The process view is specified as, in a preferred embodiment, a Meta-Object Facility (MOF) compliant metamodel. Using model transformation techniques known in the art and available to the inventor, these metamodels (process views) are transformed into Esterel program specifications. The Esterel specification can be further compiled into an FC2 format using an Esterel language compiler and oc2/fc2 and FC2 tools.

Generated automation may be limited by using fc2min to limit the additional states introduced by the Esterel compiler. DFA library 708 may be a MONA library. The resulting automation may be imported into a MONA environment so that the DFA library may be accessed. A DFA import tool (not illustrated) is provided that converts FC2 formatted data to DFA object data using a dfaBuild function.

MONA's base DFA functions are used to implement the analysis of integration safety and completeness for each of the process views and all compositions. More detail about the process of validating process views is provided further below.

The process integration tool set or framework 601 essentially bridges the abstraction gap that exists between standard business process modeling notations and specifications required for rigorous process integration analysis. The process of the invention automatically translates high-level business process notation into process automata. The framework of the present invention also provides an environment of automation for created operators used to validate the integration process for safety and completeness properties.

It will be apparent to one skilled in the art of business process modeling and transformation that there are a variety of languages and tools that may be used or not used in the process. The inventor uses a natural transformation process from industry standard BPEL4WS to DFA format. The process described above is not meant to infer any limitations, but is just one example of a way to automate process integration and validate the success of the integration. It is also noted that there may be many Legacy system processes and services that need to be integrated with multiple new component processes and services. The goal of framework 601 is to automate the process as much as is possible and to pinpoint any problems and enable quick display of any problems so that they may be quickly mitigated.

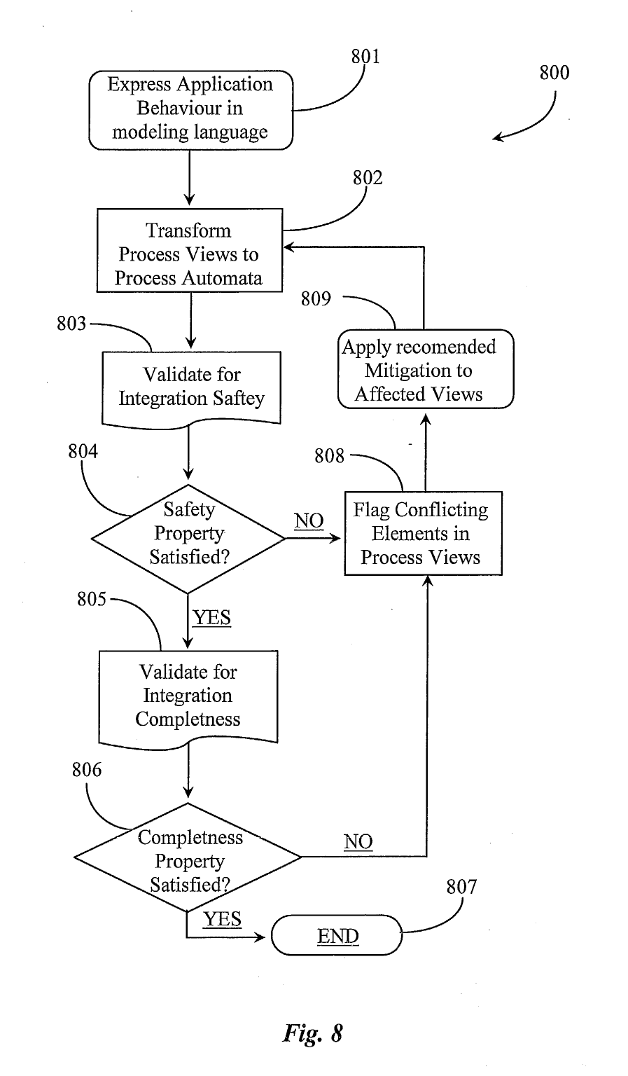

FIG. 8 is a process flow diagram illustrating steps 800 for integrating business processes and for validating the safety and completeness of the integration process according to an embodiment of the present invention. At step 801 application behavior is expressed in modeling language. More specifically, process views are created using BPEL4WS or some other suitable business process modeling language.

The models created in this embodiment are termed process views in the art before being transformed into process automata. At step 802, the process views modeled in step 801 are transformed into a finite state automaton or process automata. In this representation, enterprise application behavior is expressed as a control flow over a set of process activities. A process activity may be thought of as an offered service or manual task. In the process view, which is a finite state automaton, process states are the states of automaton, process activities are the alphabets or events, and the arbitrary flow of activities represents state transition relations.

In this embodiment, both parallelism and synchronization between activities are addressed. These conditions are addressed by flattening out any possible interleaving of activities in parallel. The special finite state automaton is collectively and formally termed process automata. A process automaton (P) has 5 sub-components in one embodiment. These components are P (S, E, T, s, F) where . . .
S: Finite non-empty set of process states.
E: Finite set of events. The set of activities are mapped into the events of process automaton. The events are categorized, based on the interaction patterns of the activities, into two types. Those are Input Events (I) and Output Events (O) i.e. E=I ∪ O.
T: Non Empty set of transitions. Transition tε T is defined as, s→s′, where s is the source state, s′ is the target state and E is the input or output event. It assumed that all transitions are deterministic transitions.
s: Start state (s ε S). It assumed that there is no incoming transition to the start state.
F: Set of final states (F ε S). It assumed that final states have no outgoing transition.

In one embodiment, a subset of the Esterel language with an extension for representing event types is used to specify the process automata. In this embodiment the concepts of process, goal and composition setting are the basic criterion for the analyses in the process automata environment. A process represents a process view of an application. Goal, is a sub-process automaton and provides a finer level of granularity of a process to verify the partial fulfillment of the desired properties. Goal contains subset of traces accepted by a process. Composition setting describes an integrative configuration to capture the notion of the desired integrated process view. In formal terms, composition setting (CS) is 2-tuple (P_{D}, P_{C}), where
P_{D}=the process automaton of the desired process
P_{C}={P₁, P₂, . . . , Pₖ} is a set of process automata of participating processes.

The collective behavior of a composition setting CS=(P_{D}, P_{C}) can be seen as product automaton P_{C}=(S_{C}, E_{C}, T_{C}, s_{C}⁰, F_{C}) of the participating process automata where
S_{C} ε(S₁×S₂× . . . ×Sₖ), E_{C}=∪_{i=i . . . k} Eᵢ,S_{C}⁰={s₁⁰,s₂⁰, . . . sₖ⁰} and
F_{C}={∀iε[1,k], (sᵢ ε Fᵢv sᵢ=sᵢ⁰)}

In a preferred embodiment, a set of operators and relations are introduced into the integration analyzing process to establish the properties desired for successful process integration, namely a safety property and a completeness property. These components are discussed later in this specification. At step 803, validation for the integration safety property is preformed.

The safety property determines the extent of reusability of an existing application in the context of the desired integrated environment and the adaptation required in case of a mismatch. A process automaton P₁ is safe with respect to process automaton P₂ if P₁ is compatible with P₂ (process orchestration) and if P₁ is in conformance with or confonns to P₂ (process coordination) where compatibility and conformance criteria are defined as follows:

Compatibility Criteria

A process P₁ is compatible with process P₂ when P₁ is at least as capable as P₂, and P₁ can substitute for P₂. The process P₁ is compatible with process P₂ if following condition is satisfied:
(Restriction(P₂, P₁) □ P₁) ˆ (Restriction(P₂, P₁)≦P₁)
Conformance Criteria

A process P₁ conforms to process P₂ when output events of P₁ can be consumed by the process P₂ as input events and vice-versa. The process P₁ conforms with process P₂ if following condition is satisfied:
(Restriction(Complement(P₂), P₁) □ P₁) ˆ (Restriction(Complement(P₂),P₁)≦P₁).

The completeness property enables ascertainment that a desired process can be realized by integrating participating processes. A given composition setting (P_{D}, P_{C}) is complete if the following conditions are satisfied:

1. Composition setting satisfies the event inclusion relation.

2. Composition setting is safe i.e. ∀i □[1,k], where k=|P_{C}|, the process compatibility criteria holds for process Pᵢ with respect to desired process P_{D} i.e. Restriction(P_{D}, Pᵢ, Mᵢ)≦Pᵢ, and

3. Desired process automaton can be collectively simulated by the set of participating process automata i.e. P_{D}≦_{C} P_{C}.

The conditions 1 and 2 above are sufficient to ascertain behavioral completeness under a simplifying assumption, termed as uniqueness assumption. The uniqueness assumption ensures that a particular event E triggers at most one transition in a process automaton.

At step 804, a decision is made as to whether the safety property is satisfied in the integration process. If the safety property is satisfied in step 804, at step 805, the process validates for integration completeness.

At step 806 it is determined during the validation whether the completeness property has been satisfied. If it has, then the process ends at step 807.

Referring now back to the discussion of operators and relations introduced into the analyzing process, it is preferred that these components operate during the process to help streamline the process and to help realize a fully safe and completely integrated enterprise application.

A restriction (P1, P2) operator is provided where a process P₁ restricted by process P₂ implies that the restricted process P_{R} of process P₁ contains only those transitions for which the corresponding transitions are present in process P₂. To further explain, consider that there might be two process P₁=(S₁, E₁, T₁, s₁, F₁) and P₂=(S₂, E₂, T₂, s₂, F₂) and the restricted process is P_{R}=(S_{R}, E_{R}, T_{R}, S_{R}, F_{R}). Then the restriction operator ignores the transitions (Δ) with labels where e ε (E₁−E₂) from process P₁, i.e. Restriction (P₁, P₂)=Ignore(P₁, (E₁−E₂)).

For given a set of events I, and a process P, the ignore operator computes a transitive closure graph by considering the set of moves triggered by eε I as epsilon moves. The resultant automaton is constructed by performing the following steps: an equivalent automaton is constructed by treating events I as the epsilon, and then, the resulting automaton is determinized by a subset construction algorithm.

A compliment operator is provided where the operator compliments the interaction patterns by converting the types of the events of a process automaton. Given a process P=(S, E, T, s, F), the complement process automaton is P̅=(S, E̅, T̅, s, F), where
E̅={∀ e ε E, complement(e)}, where E=I∪O

$$\overline{E} = \{ ∀ e ∈ E , complement ( e ) \} , where E = I ⋃ O$$

$$\overline{T} = \{ ∀ e ∈ E , s {⟶}^{\overline{e}} {s}^{′} such that x {⟶}^{e} {s}^{′} ∈ T \}$$

$$where$$

$$\overline{e} = complement ( e )$$

An event inclusion relation is provided. Let P₁=(S₁, E₁, T₁, s₁⁰, F₁) and P₂=(S₂, E₂, T₂, S₂⁰, F₂) be two process. Event inclusion relation, of a process P₁ with respect to another process P₂ is (denoted by P₁ □ P₂) defined as
∀e₁ εE₁, ∃ e₂ εE₂ s.t. (e₁=e₂) ˆ(Type(e₁)=Type(e₂))
An event inclusion relation for a composition setting (P_{D}, P_{C}), where P_{D}=(S_{D}, E_{D}, T_{D}, s_{D}⁰, F_{D}) is desired process automaton and P_{C}=(S_{C}, E_{C}, T_{C}, s_{C}⁰, F_{C}) is collective process automaton of participating process automata P₁,P₂, . . . ,Pₖ, is defined as follows
∀e₁ ε E_{d}, ·∃ e₂ ε E_{c} s.t. (e₁=e₂) ˆ(Type(e₁)=Type(e₂))
A simulation relation is provided. Let P₁=(S₁, E₁, T₁, s₁⁰, F₁) and P₂=(S₂, E₂, T₂, s₂⁰, F₂) be two processes. A relation R ε S₁×S₂ is called a simulation if it satisfies the following condition:

$$∀ {s}_{1} ∈ {S}_{1} , {s}_{1}^{′} ∈ {S}_{1} and {s}_{2} ∈ {S}_{2}$$

$$if \\ ( {s}_{1} , {s}_{2} ) ∈ R , \\ {s}_{1} {⟶}^{e} {s}_{1}^{′} then ∃ {s}_{2}^{′} s . t . {s}_{2} {⟶}^{e} {s}_{2}^{′} ⋀ ( {s}_{1}^{′} , {s}_{2}^{′} ) ∈ R$$

A process P₂ simulates process P₁ (denoted by P₁≦P₂) if there exists a simulation relation R ΕS₁×S₂ such that (s₁⁰, s₂⁰) ε R

A partial simulation relation is provided. Let P₁=(S₁, E₁, T₁, s₁⁰, F₁) and P₂=(S₂, E₂, T₂, s₂⁰, F₂) be two processes. A relation R_{P} ε S₁×S₂ is called a partial simulation if

$$∀ {s}_{1} ∈ {S}_{1} , {s}_{1}^{′} ∈ {S}_{1} and {s}_{2} ∈ {S}_{2}$$

$$if \\ ( {s}_{1} , {s}_{2} ) ∈ Rp , {s}_{1} {⟶}^{e} {s}_{1}^{′}$$

$$then$$

$$( ( {s}_{2} ∈ {F}_{2} ) ⋁ ( ∃ {s}_{2}^{′} ∈ {S}_{2} s . t . {s}_{2} {⟶}^{e} {s}_{2}^{′} ⋀ ( {s}_{1}^{′} , {s}_{2}^{′} ) ∈ Rp )$$

A state s₂ of process P₂ partially simulates a state s₁ of process P₁ (denoted by s₁≦_{P} s₂) if there exists a partial simulation relation R_{P} ε S₁×S₂ such that (s₁, s₂) ε R_{P}. The concept of partial simulation relation is used to verify partial fulfillment of a process with respect to desired process.

A collective simulation relation is provided. Let (P_{D}, P_{C}) is a composition setting where P_{D}=(S_{D}, E_{D}, T_{D}, s_{D}⁰, F_{D}) is desired process and P_{C}=(S_{C}, E_{C}, T_{C}, s_{C}⁰, F_{C}) is collective process of participating process P₁,P₂, . . . ,Pₖ. A relation R ε S_{D}×S_{C} is called a collective simulation if it satisfies the following conditions:

$$∀ {s}_{d} ∈ {P}_{D} , {s}_{d}^{′} ∈ {P}_{D} and s = \{ {s}_{1} , {s}_{2} , … , {s}_{k} \} ∈ {S}_{C}^{0}$$

$$if \\ ( {s}_{d} , s ) ∈ R , {s}_{d} {⟶}^{e} {s}_{d}^{′}$$

$$then$$

$$∃ {s}^{′} such that s {⟶}^{e} {s}^{′} ⋀ ( {s}_{d}^{′} , {s}^{′} ) ∈ R$$

Where transition over the set of states of the participating process automata is as follows:

$$\text{-} s {⟶}^{e} {s}^{′} ,$$

there exists at least a i such that

$${s}_{i} {⟶}^{e} {s}_{i}^{′}$$

where i ε[1,k])

The rest of the states of s remain same in s′.

The desired process P_{D} is collectively simulated by the set of participating processes {P₁, . . . ,Pₖ} (denoted by (P_{D}≦_{C} P_{C})) if the initial state (s_{D}⁰) of process P_{D} is collectively simulated by s_{C}⁰ where s_{C}⁰ is the set of initial states {i □ [1,k], sᵢ⁰} of set of participating process (Pᵢ). The notion of collective simulation is used for reasoning a composition setting in the context of integration.

The operators and relations described occur in the analyzing process and are part of the notation of the process automata. As long as the safety and completeness properties are satisfied in steps 804 and 806 then the process can end. It should be noted herein that the decision steps 804 and 806 and associated validation steps 803 and 805 may occur in the opposite order or at the same time without departing from the spirit and scope of the present invention. One of the properties of finite deterministic automata is that one input can occur and be resolved to one output before another input is received and the output is predictable unlike non-deterministic automata.

Referring now back to step 804, if it is determined that the safety property was not satisfied, then in step 808 the system flags the conflicting element or elements in the process views that need to be mitigated. At step 809, the operator or user has an opportunity to mitigate the problem or problems cited and may apply the solutions to the affected process views. It is noted here that in one embodiment, errors, conflicts, and obstacles to safe integration are presented within the context of the process view in BPEL-based format. After mitigating the problem in step 809, the process may resolve back to step 802 where the mitigated process view or views are transformed again into process automata.

If in step 806, the completeness property is not satisfied, then the process resolves to steps 808, 809, and 802 as described above with respect to a negative at step 804. The process may loop until all of the bugs are ironed out if there are any bugs detected at all. The importance of automating and restricting or constraining the process of analyzing the process automata is that much manual work can be eliminated with respect to looking for conflicts to a safely and completely integrated enterprise application.

One with skill in the art of process modeling will realize that the process described herein may be implemented using a variety of modeling languages and transformation techniques without departing from the spirit and scope of the present invention. The present invention enables quick validation of process integration in near real time as the business processes are executed. The solution including the framework and tool sets can be offered as a turnkey in-house solution or as an online solution without departing from the spirit and scope of the present invention. The spirit and scope of the present invention is limited only by the claims that follow.

What is claimed is:

1. In a system for bridging one or more legacy systems with one or more component systems for data communication, a method for integrating application processes with one another comprising steps of:
(a) expressing all application behavior using a modeling language;
(b) transforming those expressions into process automata;
(c) organizing composition settings comprising the process automata; and
(d) analyzing process automata for integration safety and for integration completeness properties of the process automata using a deterministic finite automata library and leveraging its base functions.

2. The method of claim 1, wherein in step (a), the modeling language used is business process execution language based.

3. The method of claim 1, wherein in step (a), the applications are both internal and external applications with respect to the enterprise.

4. The method of claim 1, wherein in step (b), the expressions represent process views of the applications.

5. The method of claim 1, wherein in step (b), the process automata are expressed in Esterel programming language.

6. The method of claim 1, wherein in step (b), an integration safety property and an integration completeness property are introduced and specified for each process automation as part of the transformation.

7. The method of claim 1, wherein in step (c), the composition setting comprises the process automata of the application desired to be integrated and process automata of participating applications.

8. The method of claim 6, wherein the integration safety property has the sub-attributes of compatibility and conformance.

9. The method of claim 1, further including step (e), for providing feedback to a system operator of any conflict to safe or complete business process integration found in step (d).

10. A process integration framework for enabling business process integration for multiple enterprise applications comprising:
a model transformation module;
a language compiler; and
an analyzer module having access to a code library;
characterized in that a desired application process automation is analyzed for integration safety and integration completeness in the context of other participating application process automata.

11. The framework of claim 10, integrated with a system for bridging one or more legacy systems for communication with one or more new component systems.

12. The framework of claim 10, installed on a single machine connected to a network.

13. The framework of claim 10, installed over two or more machines connected to a network.

14. The framework of claim 10, wherein the model transformation module converts BPEL4WS to Esterel and the language compiler is an Esterel compiler.

15. The framework of claim 10, wherein the code library is a deterministic finite automata library.

16. The framework of claim 10, wherein the analyzer leverages the base functions of the library to analyze the process automata.

17. The framework of claim 10, wherein the safety and completeness properties are specified using operators and relations.

18. The framework of claim 17, wherein the operators and relations include a restriction operator, a compliment operator, an event inclusion relation, a simulation relation, a partial simulation relation, and a collective simulation relation.
